(19) United States
(12) Patent Application Publication
(10) Pub. No.: US 2019/0294431 A1
(43) Pub. Date: Sep. 26, 2019

(54) ON-BOARD UPDATE SYSTEM AND ON-BOARD UPDATE DEVICE

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-shi (JP)

(72) Inventor: Takahiro Saito, Yokkaichi, Mie (JP)

(21) Appl. No.: 16/344,898

(22) PCT Filed: Oct. 27, 2017
(86) PCT No.: PCT/JP2017/038836

§ 371 Date: Apr. 25, 2019

(30) Foreign Application Priority Data
Oct. 31, 2016 (JP) 2016-213359

(51) Int. Cl. G06F 8/654; B60R 16/023; B60R 16/033

(52) U.S. Cl. CPC G06F 8/654; B60R 16/033; B60R 16/0231

(57) ABSTRACT

Provided is an on-board update system and an on-board update device that can suppress battery exhaustion associated with update processing of an on-board apparatus. An on-board update system according to the present embodiment is provided with: an on-board apparatus that operates by receiving power supplied from a battery that is installed in a vehicle and executing a program stored in a storage unit; a first relay that is arranged in a power supply path from the battery to an on-board electronic component that is installed in the vehicle, the first relay switching the power supply path between conduction and interruption; an on-board update device that includes an update processor that performs processing that updates the program that is stored in the storage unit of the on-board apparatus; and a switch control unit that switches the first relay to an interrupted state when the update processor performs update processing.

### CROSS-REFERENCE TO RELATED APPLICATIONS

This application is the U.S. national stage of PCT/JP2017/038836 filed Oct. 27, 2017, which claims priority of Japanese Patent Application No. JP 2016-213359 filed Oct. 31, 2016, the contents of which are incorporated herein.

### TECHNICAL FIELD

The present disclosure relates to an on-board update system and on-board update device that update a program of an on-board apparatus that is installed in a vehicle.

### BACKGROUND

Vehicles are conventionally installed with a plurality of on-board apparatuses such as ECUs (Electronic Control Units) that are connected via communication lines such as CAN (Controller Area Network) buses which make the on-board apparatuses capable of transmitting and receiving information to and from each other. The ECUs perform various processes such as control of the vehicle through processing devices such as CPUs (Central Processing Units) reading out and executing programs stored in storage units such as flash memories or EEPROMs (Electrically Erasable Programmable Read Only Memories). Programs or data stored in the ECU storage units need to be updated with new programs or data whenever necessary, such as when adding functions, addressing problems, or performing version updates. In this case, programs or data for updating are transmitted via communication lines to the ECUs that are subject to update processing.

JP 2011-70287A proposes a program update system in which, when updating a program after the driver has exited a vehicle while the engine is running, a program update device monitors the state of the vehicle and transmits the monitored state to a center, and the center monitors the state of the vehicle while the program updates.

With the program update system described in JP 2011-70287A, a program can be updated while the engine of a vehicle is running. However, it is conceivable to want to update a program while the engine has stopped, at which time it is highly unlikely that a user will use the vehicle. When updating a program while the engine has stopped, it is necessary to use power stored in a battery of the vehicle to activate the ECU that is to be updated. Thus, if the ECU to be updated is connected to the battery via a relay such as an IG (Ignition) relay or an ACC (Accessory) relay, control is performed that switches the relay to a conductive state when updating a program.

By controlling the conduction of the relay in this a way, power from the battery can also be supplied to an ECU that is not to be updated, another electronic component, or the like that is connected to the relay or a different relay that is interconnected with that relay. It is possible to stop the operation of the ECU to which update processing is not to be performed by, for example, transmitting a stop operation command to this ECU via an in-vehicle network. However, if an electronic component is present that cannot have its operation stopped in such a way, there is concern that this electronic component may consume power and exhaust the battery during update processing. If the electronic component is a connection portion, such as a cigar lighter socket of a vehicle, to which the user can connect an apparatus, then it may be difficult to estimate how much power will be used by the apparatus that is connected to the connection portion.

The present disclosure has been made in view of such circumstances and an object thereof is to provide an on-board update system and on-board update device that can prevent update processing of an on-board apparatus from exhausting a battery.

### SUMMARY

The on-board update system according to an aspect of the present disclosure is provided with: an on-board apparatus that operates by receiving power supplied from a battery that is installed in a vehicle and executing a program stored in a storage unit; a first relay that is arranged in a power supply path from the battery to an on-board electronic component that is installed in the vehicle, the first relay switching the power supply path between conduction and interruption; an on-board update device that includes an update processor that performs processing that updates the program that is stored in the storage unit of the on-board apparatus; and a switch control unit that switches the first relay to an interrupted state when the update processor performs update processing.

Also the on-board update system according to another aspect of the present disclosure has an update processor that performs update processing when the engine of the vehicle has stopped.

Also the on-board update system according to another aspect of the present embodiment has a second relay that is arranged in the power supply path from the battery to the on-board apparatus and that switches the applicable power supply path between conduction and interruption, and has a third relay that is arranged in the power supply path from the battery to the first relay and that switches the applicable power supply path between conduction and interruption, and the switch control unit switches the second relay and the third relay to a conductive state when the update processor performs updating.

Also, the on-board update system according to another aspect of the present disclosure uses a semiconductor fuse as the first relay.

Also, the on-board electronic component of the on-board update system according to another aspect of the present disclosure is a connection portion to which a power supply line can be detachably connected.

Also, the connection portion of the on-board update system according to another aspect of the present disclosure is a cigar lighter socket.

Also, the on-board update device of the on-board update system according to another aspect of the present disclosure includes the switching control unit.

Also, the on-board update device according to the present disclosure has an update processor that performs processing that updates a program that is stored in a storage unit of an on-board apparatus that operates by being supplied power from a battery installed in a vehicle, and a switch control unit that switches a first relay that is arranged in a power supply path from the battery to an on-board electronic component that is installed in the vehicle, when the update processor performs update processing.

In the present disclosure, the on-board update device performs update processing of a program that is stored in the storage unit of an on-board apparatus. The vehicle is installed with an on-board apparatus that is subject to update processing and an on-board electronic component that is not subject to update processing, and these are supplied power from the battery of the vehicle. The first relay is provided in the power supply path from the battery to the on-board electronic component, and the first relay switches to an interrupted state when the on-board update device updates the on-board apparatus. Thus, the depletion of power stored in the battery can be suppressed because power is not supplied from the battery to the on-board electronic component when the on-board apparatus is being updated.

Also, in the present disclosure, the on-board update device performs update processing of the on-board apparatus when the engine of the vehicle has stopped. Thus, it is possible to safely perform update processing of the on-board apparatus without affecting the running of the vehicle.

Also, in the present disclosure, the second relay is arranged in the power supply path from the battery to the on-board apparatus, and the third relay is arranged in the power supply path from the battery to the first relay. The second relay and the third relay may be referred to as, for example, an IG relay or an ACC relay. These relays are in an interrupted state when the engine of a vehicle has stopped, but switching these relays to a conductive state when the on-board update device performs update processing makes update processing possible even when the engine has stopped.

Also, in the present disclosure, a semiconductor fuse is used to constitute the first relay. The power supply path from the battery to the on-board electronic component is provided with a fuse for preventing overcurrent, but it is possible to reduce the number of components by using a semiconductor fuse to combine the overcurrent prevention fuse and the first relay.

Also, in the present disclosure, the on-board electronic component that has its supply of power interrupted by the first relay at the time of update processing can be a connection portion, such as a cigar lighter socket, to which a power supply line can be detachably connected. Because an occupant of the vehicle can connect a device to such a connection portion, there is concern that a device may be connected whose operation consumes an excessive amount of power and update processing thereof may exhaust the battery. Interrupting the supply of power to such a connection portion makes it possible to perform update processing without exhausting the battery, regardless of the type of device connected to the connection portion.

Also, in the present disclosure, the on-board update device switches between conduction and interruption by means of the first relay. Because the on-board update device is a device that performs update processing of an on-board apparatus, the on-board update device can easily and appropriately switch the first relay in accordance with update processing.

### Advantageous Effects of Disclosure

The present disclosure is configured such that the first relay provided in the power supply path from the battery to the on-board electronic component is switched to an interrupted state when an on-board electronic apparatus is being updated. Therefore, the supply of power from the battery to the on-board electronic component can be interrupted during update processing of the on-board apparatus, and thus exhaustion of the battery associated with update processing of the on-board apparatus can be suppressed

### BRIEF DESCRIPTION OF DRAWINGS

FIG. 1 is a block diagram showing a configuration of an on-board update system according to a present embodiment.

FIG. 2 is a block diagram showing a configuration of the on-board update device according to the present embodiment.

FIG. 3 is a flowchart showing a procedure of processing performed by the on-board update device according to the present embodiment.

FIG. 4 is a flowchart showing a procedure of processing performed by the on-board update device according to the present embodiment.

FIG. 5 is a block diagram showing a configuration of an on-board update system according to a first variation.

FIG. 6 is a block diagram showing a configuration of an on-board update system according to a second variation.

FIG. 7 is a schematic diagram for illustrating a semiconductor fuse according to the second variation.

### DETAILED DESCRIPTION OF PREFERRED EMBODIMENTS

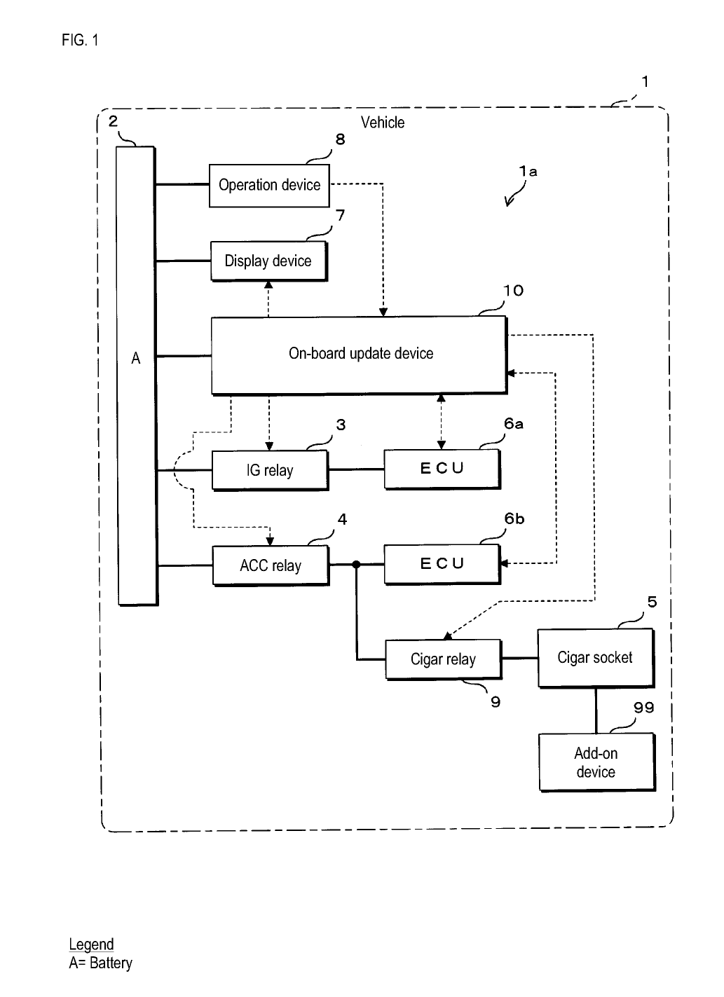

FIG. 1 is a block diagram showing a configuration of an on-board update system 1a according to the present embodiment. Note that in this diagram, the thick solid lines represent power supply paths, and the broken lines represent signal transmission paths. Also, reference numeral 1 in the drawings is a vehicle and is indicated by an alternately long and short dashed line. The vehicle 1 includes a battery 2, an IG relay 3, an ACC relay 4, a cigar lighter socket 5, ECUs 6a and 6b, a display device 7, and an operation device 8 The battery 2 is a device that stores power generated by an alternator (not shown) during the operation of the engine of the vehicle 1, and can be constituted by a battery such as a lead storage battery or a lithium ion battery. The battery 2 supplies stored power to an on-board apparatus, such as ECUs 6a and 6b that are installed in the vehicle, while the engine of the vehicle 1 has stopped.

The IG relay 3 is arranged in the power supply path from the battery 2 to an on-board apparatus such as the ECU 6a, and switches the power supply path between conduction and interruption. Note that in FIG. 1, only one ECU 6a is connected to the IG relay 3, but there is no limitation thereto, and a plurality of on-board apparatuses may be connected. The IG relay 3 is switched between conduction and interruption depending on the status of an ignition switch (not shown) for performing an operation that switches the state of the engine start-up and the power supply of the on-board apparatus of the vehicle 1. The IG relay 3 is switched to a conductive state during the operation of the engine of the vehicle 1, and switched to an interrupted state when the engine has stopped.

The ACC relay 4 is arranged in the power supply path from the battery 2 to an on-board apparatus such the ECU 6b and an on-board electronic component such as the cigar lighter socket 5, and switches the power supply path between conduction and interruption. Note that in FIG. 1, only one ECU 6b and one cigar lighter socket 5 are connected to the ACC relay 4, but there is no limitation thereto, and other on-board apparatuses or on-board electronic components may be connected. The ACC relay 4 is also switched between conduction and interruption depending on the state of the ignition switch of the vehicle 1. The switching of the IG relay 3 between conduction and interruption and the switching of the ACC relay 4 between conduction and interruption are interconnected, with the ACC relay 4 being in a conductive state if the IG relay 3 is in a conductive state, and the IG relay 3 being in an interrupted state if the ACC relay 4 is in an interrupted state. However, there may be cases where the IG relay 3 is in an interrupted state and the ACC relay 4 is in a conductive state.

The cigar lighter socket 5 is a socket for a cigar lighter and is provided in the vicinity of the driver's seat of the vehicle 1. However, the cigar lighter socket 5 can also be used as a connection portion for supplying power to an external component instead of for a cigar lighter, and in this case the lighter socket may also be called an accessory socket, a power source socket, or the like. Various add-on devices 99 can connect to the cigar lighter socket 5 via what is called a car cable, that is, a power source cable that is provided with a terminal. In a state in which the add-on device 99 is connected to the cigar lighter socket 5, power can be supplied from the alternator or the battery 2 of the vehicle 1 to the add-on device 99 if the ACC relay 4 is switched to a conductive state, and the add-on device 99 can operate on this power.

ECUs 6a and 6b can include various ECUs, such as an ECU that controls the operation of the engine of the vehicle 1, an ECU that controls the locking and unlocking of a door, an ECU that controls the turning on and off of a light, an ECU that controls the operation of an airbag, and an ECU that controls the operation of an ABS (Antilock Brake System). ECUs 6a and 6b perform a variety of processes by a CPU (Central Processing Unit) or the like executing programs that have been stored in an internal memory or the like. In the present embodiment, the ECU 6a is the ECU that is subject to update processing that updates a program stored in a memory or the like, and is connected to the battery 2 via the IG relay 3.

The display device 7 is, for example, a liquid crystal display or the like, and displays messages or images to a user of the vehicle 1. The operation device 8 is a device such as a push-switch, a dial-switch, or a touch-switch, is arranged in the vicinity of the driver's seat of the vehicle 1, and is for receiving a user operation. Note that the display device 7 and the operation device 8 may be shared with, for example, a car navigation device. Also, in the present embodiment, the display device 7 and the operation device 8 are configured to directly receive power supplied from the battery 2, but there is no limitation thereto. The display device 7 and the operation device 8 may also be configured to be connected to the IG relay 3 or the ACC relay 4 via the battery 2.

Also, the on-board update system 1a according to the present embodiment includes an on-board update device 10, a cigar relay 9, and the like. The on-board update device 10 performs processing that updates a program or data (hereinafter simply “program”) that are stored in the memory of the ECU 6a or the like. The on-board update device 10 performs communication with, for example, a sever outside of the vehicle while the engine of the vehicle 1 is operating, queries as to whether or not a program of the ECU 6a needs updating, and, if an update is necessary, downloads and stores the program for updating. When the engine of the vehicle 1 has stopped or before it stops, the on-board update device 10 queries whether or not an update is to be permitted by displaying a message on the display device 7 giving notice that a program of the ECU 6a needs updating, and the on-board update device 10 receives the user's selection as to whether or not the program is permitted to update through the operation device 8. If permission to update is received, the on-board update device 10 performs update processing by transmitting a previously recorded update program for updating to the ECU 6a that is to be updated when a predetermined timing is reached, such as after a predetermined time lapses from when the engine of the vehicle 1 stops.

However, in the present embodiment, the ECU 6a that is to be updated is connected to the battery 2 via the IG relay 3. When the engine of the vehicle 1 has stopped, the IG relay 3 is in an interrupted state, the ECU 6a is not supplied power from the battery 2, and thus the ECU 6a cannot operate. The on-board update device 10 according to the present embodiment can control switching of the IG relay 3 and the ACC relay 4, and allows the ECU 6a that is to be updated to operate by switching the IG relay 3 to a conductive state when update processing of the ECU 6a is performed.

However, as described above, the IG relay 3 and the ACC relay 4 are interconnected, and thus the ACC relay 4 is also in a conductive state if the IG relay 3 is in a conductive state. If the on-board update device 10 switches the IG relay 3 to a conductive state in order to perform update processing of the ECU 6a, the ACC relay 4 also switches to a conductive state. For this reason, if the add-on device 99 is connected to the cigar lighter socket 5, power is supplied from the battery 2 to the add-on device 99 when the on-board update device 10 performs update processing. The add-on device 99 is a device that is connected according to the preferences or needs of the user, and there is absolutely no need for the add-on device 99 to be operated for update processing of the ECU 6a nor for power supply from the battery 2.

In the present embodiment, the cigar relay 9 is provided in the power supply path from the ACC relay 4 to the cigar lighter socket 5. The cigar relay 9 switches this power supply path between conduction and interruption in response to a control signal from the on-board update device 10. Note that in the present embodiment, the cigar relay 9 is arranged close to the cigar lighter socket 5 and interrupts the supply of power to the cigar lighter socket 5, but does not interrupt the supply of power to other on-board apparatuses or on-board electronic components, such as the ECU 6b that is connected to the ACC relay 4. Also, the cigar relay 9 is preferably constituted by a latch relay that does not need power to maintain a conductive state and an interrupted state.

The on-board update device 10 completes acquisition of the update program from a server device outside of the vehicle and starts update processing of the ECU 6a at a predetermined timing after the engine of the vehicle 1 has stopped. At this time, the on-board update device 10 first switches the cigar relay 9 to an interrupted state. Next, the on-board update device 10 switches the IG relay 3 and the ACC relay 4 to a conductive state, and transmits a command to the ECU 6b, which is not subject to update processing, to stop operating. Then, the on-board update device 10 performs update processing by transmitting the program for updating to the ECU 6a, which is subject to update processing. After update processing is complete, the on-board update device 10 switches the IG relay 3 and the ACC relay 4 to an interrupted state, and switches the cigar relay 9 to a conductive state.

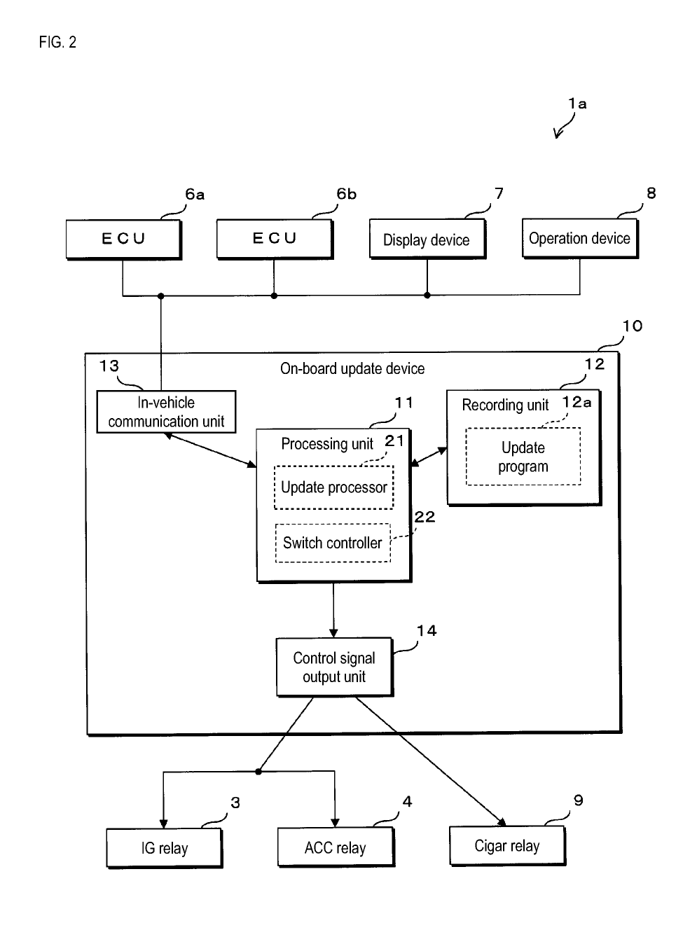

FIG. 2 is a block diagram showing the configuration of the on-board update device 10 according to the present embodiment. The on-board update device 10 according to the present embodiment includes a processing unit 11, a storage unit 12, an in-vehicle communication unit 13, a control signal output unit 14, and the like. The processing unit 11 is constituted by an arithmetic processing unit such as a CPU (Central Processing Unit) or an MPU (Micro-Processing Unit), and performs a variety of arithmetic processing by reading out and executing a program (not shown) that is stored in the storage unit 12. The processing unit 11 performs processing such as downloading a program to update the ECU 6a from a server device outside of the vehicle, querying a user for permission to perform update processing, updating a program by transmitting a downloaded program for use with updating to the ECU 6a, and the like. Also, the processing unit 11 in the present embodiment performs processing that controls the switching of the IG relay 3, the ACC relay 4 and the cigar relay 9 when update processing is performed.

The storage unit 12 is constituted by a non-volatile memory element, such as a flash memory or an EEPROM (Electrically Erasable Programmable Read Only Memory). The storage unit 12 stores programs that the processing unit 11 executes and data that is necessary to execute those programs, and stores an update program 12a that is used to update the ECU 6a. The storage unit 12 may also store data generated through the processing of the processing unit 11, and the like.

The in-vehicle communication unit 13 is connected to a communication line that constitutes an in-vehicle network that is provided in the vehicle 1, and performs transmission and reception of data in accordance with, for example, a communication protocol such as CAN (Controller Area Network) protocol. The in-vehicle communication unit 13 transmits information by converting data received from the processing unit 11 into a digital signal and outputting this signal to the communication line, receives data by sampling and acquiring the potential of the communication line, and supplies this received data to the processing unit 11. Thus, the on-board update device 10 can transmit and receive data between ECUs 6a and 6b, the display device 7, and the operation device 8, all of which are installed in the vehicle 1.

The control signal output unit 14 is connected to the IG relay 3, the ACC relay 4, and the cigar relay 9 respectively via signal lines or the like, and outputs a control signal that switches these relays between conduction and interruption according to instructions from the processing unit 11. Note that in the present embodiment, the on-board update device 10 is configured to directly perform relay switching control, but there is no limitation thereto, and a configuration is also possible in which an ECU that performs relay switching control is provided separately, and the on-board update device 10 instructs this ECU regarding relay switching. Also, in the present embodiment, switching control of the IG relay 3 and the ACC relay 4 in accordance with the operation of the ignition switch of the vehicle is not performed by the on-board update device 10, but rather by a separate ECU (not shown) that performs relay switching control.

Also, the processing unit 11 executes programs stored in the storage unit 12 to realize software-like function blocks such as an update processor 21 and a switch controller 22. The update processor 21 performs processing for updating programs stored in the storage unit of a variety of on-board apparatuses (the ECU 6a in the present embodiment) that are installed in the vehicle 1. The update processor 21 performs communication with a server device outside of the vehicle while the engine of the vehicle 1 is operating, and queries all of the on-board apparatuses to which update processing can be performed as to whether their programs need updating. If given a reply from the server device that update processing needs to be performed, the update processor 21 acquires an update program necessary for update processing from the server device and stores the update program in the storage unit 12. After the engine of the vehicle 1 has stopped, if a predetermined timing for performing update processing is reached, the update processor 21 performs update processing by reading out the update program 12a stored in the storage unit 12 and transmitting the read out update program 12a to the on-board apparatus that is subject to update processing.

When the update processor 21 performs update processing, the switch controller 22 switches the IG relay 3, the ACC relay 4, and the cigar relay 9 between conduction and interruption. The switch controller 22 gives a conduction or interruption instruction to the control signal output unit 14 for the relays, and the control signal output unit 14 accordingly outputs a control signal to switch the relays between conduction and interruption. When the update processor 21 starts update processing, the switch controller 22 first switches the cigar relay 9 to an interrupted state. Next, the switch controller 22 switches the IG relay 3 and the ACC relay 4 to a conductive state. Thus, it is possible to supply power from the battery 2 to the ECU 6a that is subject to update processing yet interrupt the supply of power to the cigar lighter socket 5. Note that at this time, the update processor 21 may perform control that decreases the amount of power consumed by the ECU 6b by giving a command to the ECU 6b that is not subject to update processing to stop operating and transition to a sleep state.

Also, after the update processor 21 has completed update processing, the switch controller 22 switches the IG relay 3 and the ACC relay 4 from a conductive state to an interrupted state. Next, the switch controller 22 switches the cigar lighter socket 5 from an interrupted state to a conductive state. Thus, the switch controller 22 can switch the relays to the same state as before the update processor 21 started performing update processing.

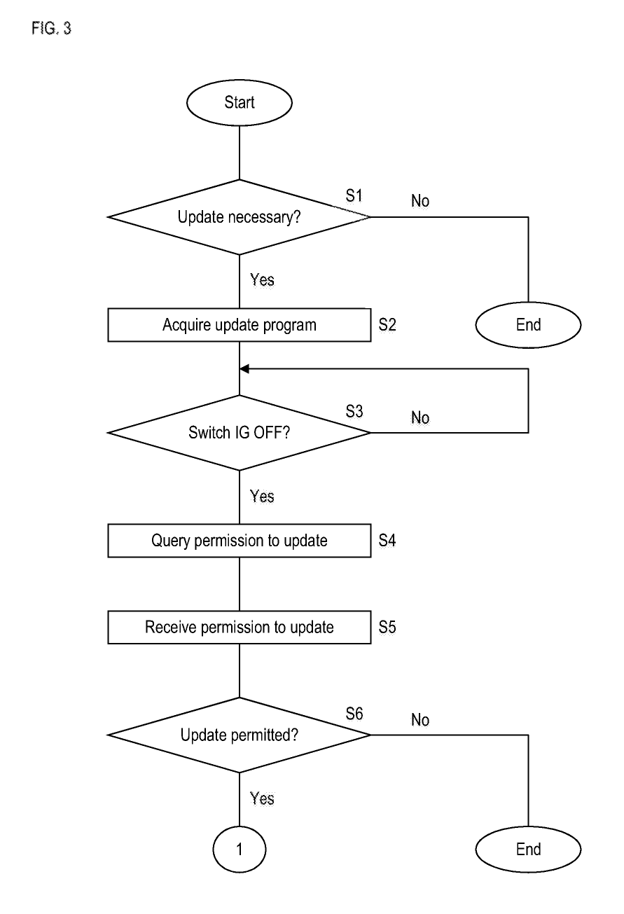

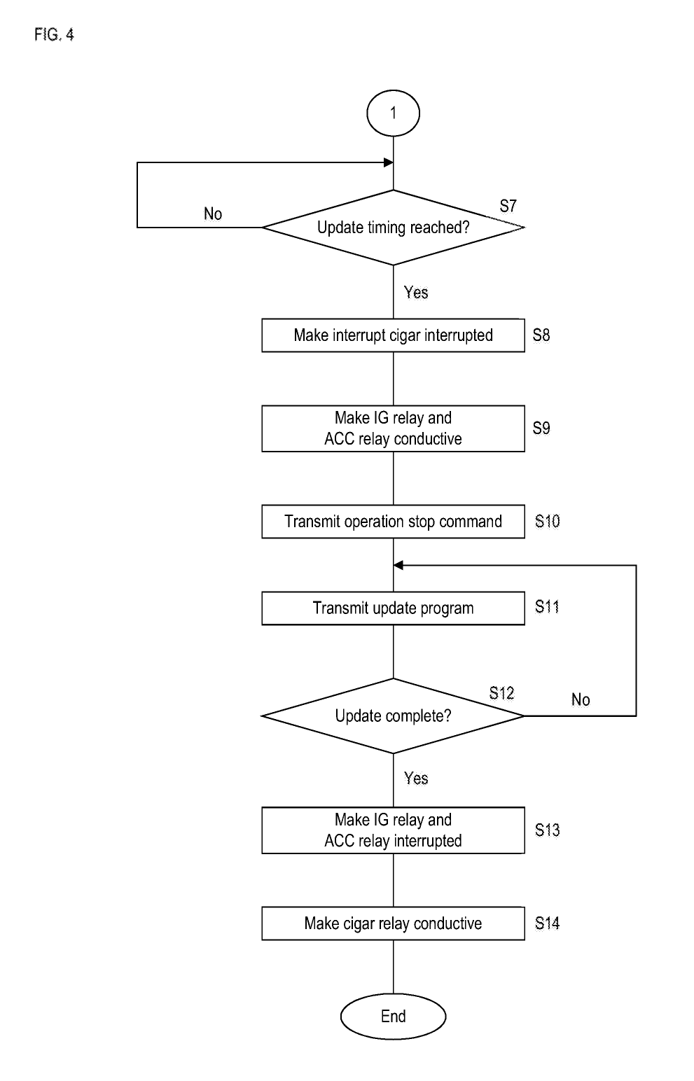

FIG. 3 and FIG. 4 are flowcharts showing procedures of processing performed by the on-board update device 10 according to the present embodiment. Note that the processing shown in these flowcharts starts from a state in which the ignition of the vehicle 1 is ON (that is, the engine of the vehicle 1 is operating). In this state, the IG relay 3, the ACC relay 4, and the cigar relay 9 of the vehicle 1 are each in a conductive state. The update processor 21 of the processing unit 11 of the on-board update device 10 uses, for example, a wireless communication device that is installed in the vehicle 1 to perform communication with a server device outside of the vehicle to determine whether or not update processing of the ECU 6a is necessary by querying as to whether or not to update a program of the ECU 6a that is installed in the vehicle 1 (step S1). If update processing is not necessary (S1: NO), the update processor 21 ends processing. If update processing is necessary (S1: YES), the update processor 21 acquires the update program that is necessary for update processing from the server device (step S2), and stores the acquired update program in the storage unit 12.

Next, the processing unit 11 determines whether or not the ignition switch of the vehicle 1 has been switched from an ON state to an OFF state (step S3). If the ignition switch is in its ON state and is not switched to its OFF state (S3: NO), the processing unit 11 waits until the ignition switch is switched to its OFF state. If the ignition switch is switched from its ON state to its OFF state (S3: YES), the processing unit 11 proceeds to step S4. Note that the ignition switch being switched to its OFF state causes the IG relay 3 and the ACC relay 4 to be switched from a conductive state to an interrupted state.

Next, the update processor 21 of the processing unit 11 gives the display device 7 an instruction through the in-vehicle communication unit 13 to display a query message, displays the query message on the display device 7 querying whether or not to permit update processing of the 6a, and thus the user is queried as to whether or not update processing is to be permitted (step S4). The message displayed at this time may read, for example, “A program of an ECU needs to be updated. Would you like this update to be performed from 11 PM today? (YES/NO)”. The update processor 21 receives the user's selection through the operation device 8, the selection being as to whether or not updating shall be permitted in answer to the query message displayed on the display device 7 (step S5). The selection as to whether or not updating shall be allowed that is accepted through the operation device 8 is transmitted to the on-board update device 10 via the in-vehicle network, received by the in-vehicle communication unit 13, and given to the processing unit 11. The update processor 21 determines whether or not permission has been obtained to perform update processing of the ECU 6a, based on the contents of the message received through step S5 (step S6). If permission for update processing has not been obtained (S6: NO), the update processor 21 ends processing without update processing.

If permission to update has been obtained (S6: YES), the update processor 21 determines whether or not a predetermined timing has been reached such that update processing is to be performed (step S7). For example, a predetermined time such as 11 PM or 2 hours from the ignition switch being switched to its OFF state can be used as the predetermined update timing. A configuration is also possible in which the user can decide the timing of the update. If the update timing has not been reached (S7: NO), the update processor 21 waits until the update timing is reached.

If the update timing has been reached (S7: YES), the switch controller 22 of the processing unit 11 switches the cigar relay 9 from a conductive state to an interrupted state (step S8). Then, the switch controller 22 switches the IG relay 3 and the ACC relay 4 from an interrupted state to a conductive state (step S9). Also, the update processor 21 of the processing unit 11 transmits an operation stop command through the in-vehicle communication unit 13 to the ECU 6b that is subject to update processing (step S10).

The update processor 21 reads out the update program 12a that is stored in the storage unit 12, and performs update processing by transmitting the read-out program through the in-vehicle communication unit 13 to the ECU 6a that is subject to updating (step S11). The update processor 21 determines if the update program 12a has finished transmitting and if update processing of the ECU 6a is complete (step S12). If update processing is not complete (S12: NO), the update processor 21 returns processing to step S11 and continues transmitting the update program 12a. If update processing is complete (S12: YES), the switch controller 22 switches the IG relay 3 and the ACC relay 4 from a conductive state to an interrupted state (step S13). Then, the switch controller 22 switches the cigar relay 9 from an interrupted state to a conductive state (step S14) and then ends processing.

In the on-board update system 1a according the present embodiment with the above configuration, the on-board update device 10 installed in the vehicle 1 performs update processing of programs stored in a memory such as the ECU 6a. The vehicle 1 is installed with on-board apparatuses that are subject to update processing such as the ECU 6a and on-board electronic components that are not subject to update processing such as the cigar lighter socket 5, and these are supplied power from the battery 2 of the vehicle 1. The cigar relay 9 is provided in the power supply path from the battery 2 to the cigar lighter socket 5, and the on-board update device 10 switches the cigar relay 9 to an interrupted state when the on-board update device 10 performs update processing of the ECU 6a. Thus it is possible to suppress the amount of power stored in the battery 2 from lowering because power is not supplied from the battery 2 to the cigar lighter socket 5 (nor the add-on device 99 connected to the cigar lighter socket 5) during update processing of the ECU 6a.

Also, the on-board update system 1a according to the present embodiment performs update processing of the ECU 6a when the engine of the vehicle 1 has stopped. Thus, it is possible to safely perform update processing of the ECU 6a without affecting the running of the vehicle 1.

Also, in the on-board update system 1a according to the present embodiment, the IG relay 3 is arranged in the power supply path from the battery 2 to the ECU 6a, and the ACC relay 4 is arranged in the power supply path from the battery 2 to the cigar relay 9. The IG relay 3 and the ACC relay 4 are in an interrupted state when the engine of the vehicle 1 has stopped, but the on-board update device 10 switches the IG relay 3 and the ACC relay 4 to a conductive state when update processing is performed. Thus, update processing of the ECU 6a can be realized when the engine of the vehicle 1 has stopped.

Also, in the on-board update system 1a according to the present embodiment, the on-board electronic component that has its supply of power interrupted at the time of update processing is a connection portion that is able to detachably connect the add-on device 99 via wiring or the like, such as the cigar lighter socket 5 for example. Because the user of the vehicle 1 can connect an add-on device 99 to the cigar lighter socket 5, there is concern that an add-on device 99 whose operation consumes an excessive amount of power may be connected and that update processing may exhaust the battery. The supply of power to the cigar lighter socket 5 being interrupted by the cigar relay 9 makes it possible to perform update processing without causing battery exhaustion regardless of the type of add-on device 99 connected to the cigar lighter socket 5.

Also, in the on-board update system 1a according to the present embodiment, the on-board update device 10 switches the cigar relay between conduction and interruption. The on-board update device 10 is a device that performs update processing of the ECU 6a and the like, so the switching of the cigar relay 9 in accordance with update processing can be easily and appropriately performed.

Note that in the present embodiment, a dedicated on-board update device 10 is provided in the system as a device that performs update processing of a program of the ECU 6a, but there is no limitation thereto. A configuration is possible in which a gateway device, any of the ECUs, or the like installed in the vehicle 1 perform update processing. Also in the present embodiment, the on-board update device 10 is configured to query the user of the vehicle 1 for permission to perform update processing before update processing is performed, but there is no limitation thereto. For example, the on-board update device 10 may be configured to perform update processing if an update timing is reached, without querying whether or not to perform update processing.

Also, the system configuration shown in FIG. 1 is an example, and there is no limitation thereto. For example, the ECU 6a that is subject to updating may also be connected to the battery 2 via the ACC relay 4, and not connected to the battery 2 via the IG relay 3. Also, for example, the cigar lighter socket 5 may also be connected to the battery 2 via the IG relay 3, and not connected to the battery 2 via the ACC relay 4. Also, the ECU 6a and the cigar lighter socket 5 may also both be connected to the battery 2 via a common relay (such as the IG relay 3 or the ACC relay 4). In any of these cases, it is sufficient that the cigar relay 9 is arranged in the power supply path from the IG relay 3 or the ACC relay 4 to the cigar lighter socket 5, and that the cigar relay 9 being in an interrupted state interrupts the supply of power to the cigar lighter socket 5 and does no interrupt the supply of power to the ECU 6a.

Also in the present embodiment, the on-board electronic component that interrupts the supply of power at the time of update processing is the cigar lighter socket 5, but there is no limitation thereto. The on-board electronic component may also be a connection portion of the USB (Universal Serial Bus) standard to which the add-on device 99 is detachably connected via a USB cable, and supplies power via the USB cable. The connection portion may also be a connection portion other than the cigar lighter socket 5 and a connection portion of a standard other than USB. Furthermore, the on-board electronic component is not limited to a connection portion for connecting the add-on device 99. The on-board electronic component can be directly controlled by the user of the vehicle 1 switching the power source between OFF and ON, but may also be an on-board device to which the on-board update device 10 cannot give commands to stop operation and the like through the in-vehicle communication and the like.

### First Variation

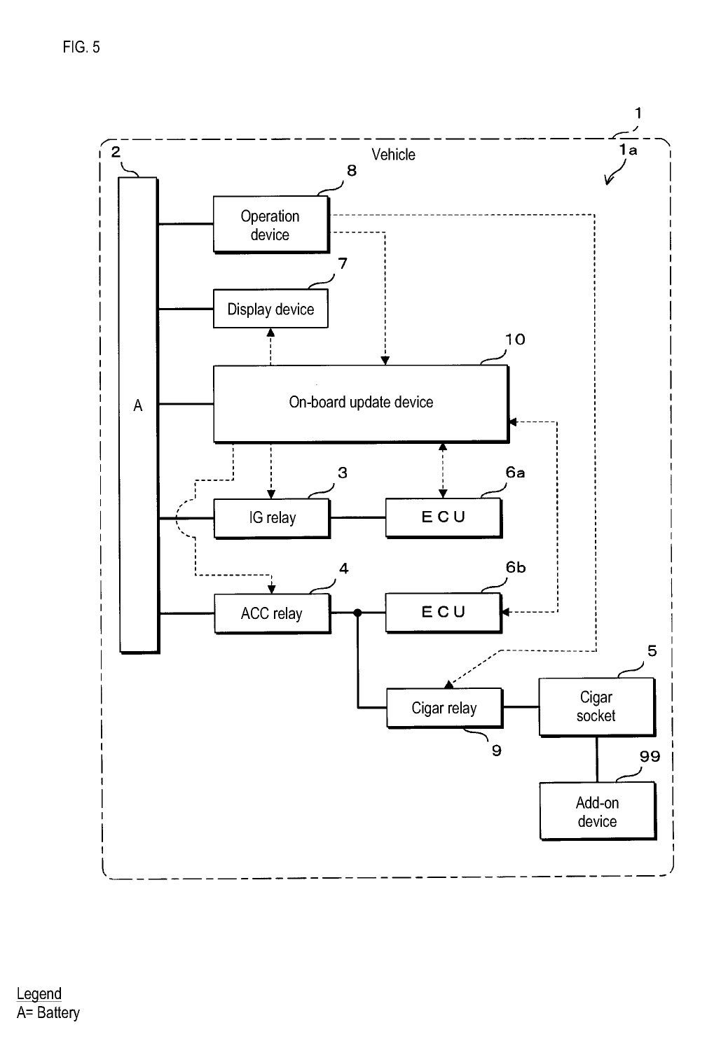

The on-board update system 1a according to the embodiment described above is configured such that the on-board update device 10, which performs update processing of the ECU 6a, switches the cigar relay 9 between conduction and interruption, but there is no limitation thereto. FIG. 5 is a block diagram showing a configuration of the on-board update system 1a according to the first variation. The on-board update system 1a according to the first variation has the operation device 8 that switches the cigar relay 9 between conduction and interruption. As described above, the operation device 8 performs processing in which a selection is received from the user regarding whether or not updating is to be permitted, in response to a query as to whether or not update processing is to be performed by the on-board update device 10. The operation device 8 according to the first variation performs processing that switches the cigar relay 9 from a conductive state to an interrupted state if the received selection permits update processing. If, for example, the ignition switch of the vehicle 1 is switched from an ON state to an OFF state, or, if a notification that update processing is complete is given from the on-board update device 10, the operation device 8 performs processing that switches the cigar relay 9 from an interrupted state to a conductive state.

Note that control that switches the cigar relay 9 between conduction and interruption may also be performed by a device other than the on-board update device 10 or the operation device 8. For example, a configuration is possible in which the device that switches the IG relay 3 and ACC relay 4 according to the switching of the ignition switch of the vehicle 1, also switches the cigar relay 9 between conduction and interruption according to an instruction from the on-board update device 10.

### Second Variation

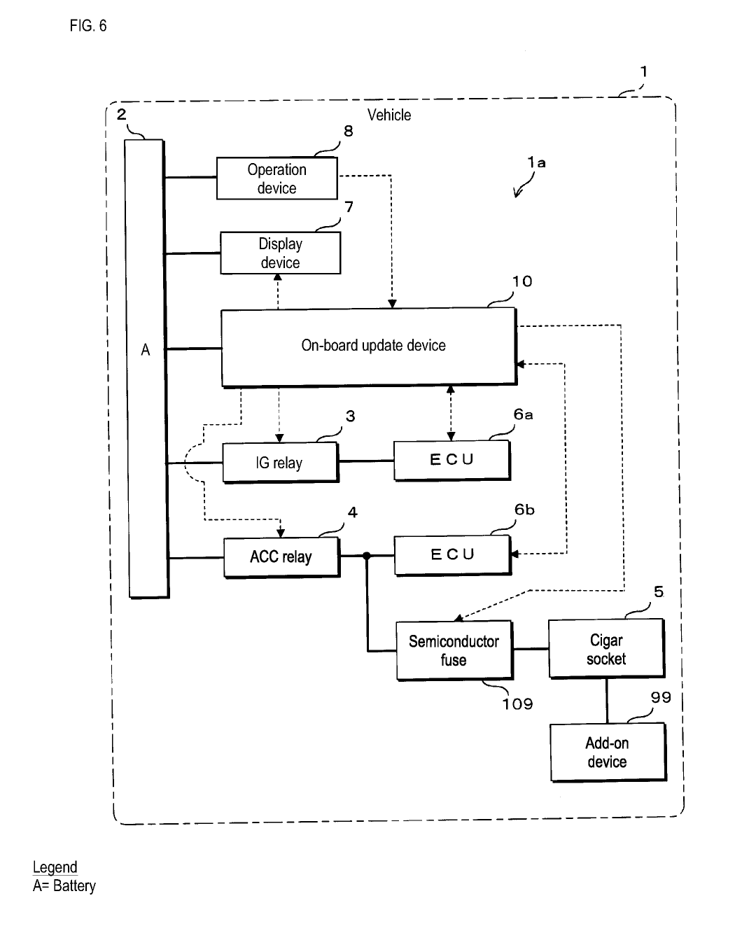

FIG. 6 is a block diagram showing the configuration of the on-board update system 1a according to a second variation. The on-board update system 1a according to the second variation uses a semiconductor fuse 109 as the cigar relay 9. The semiconductor fuse 109 is configured having a semiconductor element such as a MOSFET (Metal Oxide Semiconductor Field Effect Transistor) provided in the power supply path, and a control IC (Integrated Circuit) that detects the amount of current that flows through the semiconductor element and switches the semiconductor element between conduction and interruption. Also, the semiconductor fuse 109 can perform control that switches the semiconductor element between conduction and interruption depending on a conduction or interruption switching signal given from the on-board update device 10.

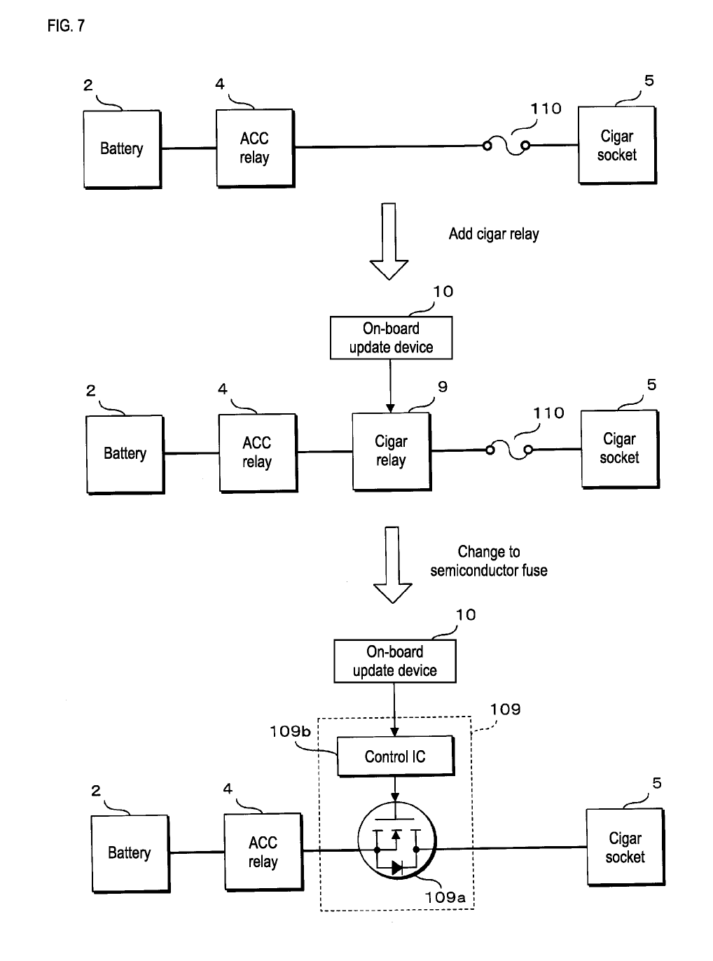

FIG. 7 is a schematic diagram for illustrating the semiconductor fuse 109 according to the second variation, which extracts and shows the power supply path from the battery 2 of the vehicle 1 passing through the ACC relay 4 to the cigar lighter socket 5. The top row of FIG. 7 shows a configuration of a conventional vehicle. In the conventional vehicle, a fuse 110 is provided in the power supply path between the ACC relay 4 and the cigar lighter socket 5. The fuse 110 is melted by overcurrent flowing therethrough, interrupts the power supply path and thus overcurrent is prevented from flowing to the add-on device 99 that is connected to the cigar lighter socket 5.

The middle row of FIG. 7 shows a configuration of the on-board update system 1a according to the embodiment above. In the on-board update system 1a according to the embodiment above, the cigar relay 9 between the ACC relay 4 and the fuse 110 is added to the conventional configuration, and the on-board update device 10 switches the cigar relay 9 between conduction and interruption. If overcurrent flows to the fuse 110 when the cigar relay 9 is in a conductive state, the fuse 110 melts and the power supply path is interrupted. When update processing of the ECU 6a is performed, the on-board update device 10 switches the cigar relay 9 to an interrupted state, thus preventing power from being supplied from the battery 2 to the add-on device 99 that is connected to the cigar lighter socket 5 during update processing.

The bottom row of FIG. 7 shows a configuration of the on-board update system 1a according to the second variation. The on-board update system 1a according to the second variation is configured such that the cigar relay 9 and the fuse 110 in the system configuration shown in the middle row of FIG. 7 are replaced with the semiconductor fuse 109. The semiconductor fuse 109 is configured having a MOSFET 109 that is arranged in the power supply path between the ACC relay 4 in the cigar lighter socket 5, and a control IC 109b that switches the MOSFET 109a between conduction and interruption. The control IC 109b detects the current that flows through the MOSFET 109a, and if for example the detected current amount exceeds a threshold value, the MOSFET 109a is switched from a conductive state to an interrupted state. Also, the control IC 109b switches the MOSFET 109a from a conductive state to an interrupted state in response to an interruption command given from the on-board update device 10. Accordingly, the MOSFET 109a is in an interrupted state if the control IC 109b detects overcurrent and if the on-board update device 10 outputs an interruption command, and in other cases is in a conductive state.

In this way, the on-board update system 1a according to the second variation is configured using the semiconductor fuse 109 as the cigar relay 9. Because the semiconductor fuse 109 is a circuit element that has both the function of the fuse 110 that is provided in the power supply path from the ACC relay 4 to the cigar lighter socket 5, and the function of the cigar relay 9, there is no need to provide the fuse 110, and it is possible to reduce the number of components such as circuit elements constituted by the on-board update system 1a.

1. An on-board update system comprising:
an on-board apparatus that operates by receiving power supplied from a battery that is installed in a vehicle and executing a program stored in a storage unit;
a first relay that is arranged in a power supply path from the battery to an on-board electronic component that is installed in the vehicle, the first relay switching the power supply path between conduction and interruption;
an on-board update device that includes an update processor that performs processing that updates the program that is stored in the storage unit of the on-board apparatus; and
a switch control unit that switches the first relay to an interrupted state when the update processor performs update processing.

2. The on-board update system according to claim 1, wherein the update processor performs update processing when an engine of the vehicle has stopped.

3. The on-board update system according to claim 1, further comprising:
a second relay that is arranged in the power supply path from the battery to the on-board apparatus and that switches said power supply path between conduction and interruption, and
a third relay that is arranged in the power supply path from the battery to the first relay and that switches said power supply path between conduction and interruption,
wherein the switch control unit switches the second relay and the third relay to a conductive state when the update processor performs updating.

4. The on-board update system according to claim 1, wherein a semiconductor fuse is used as the first relay.

5. The on-board update system according to claim 1, wherein the on-board electronic component is a connection portion to which a power supply line can be detachably connected.

6. The on-board update system according to claim 5, wherein the connection portion is a cigar lighter socket.

7. The on-board update system according to claim 1, wherein the on-board update device includes the switch control unit.

8. An on-board update device comprising:
an update processor that performs processing that updates a program that is stored in a storage unit of an on-board apparatus that operates by being supplied power from a battery installed in a vehicle, and
a switch control unit that switches a first relay that is arranged in a power supply path from the battery to an on-board electronic component that is installed in the vehicle, when the update processor performs update processing.
